(19) United States
(12) Patent Application Publication
(10) Pub. No.: US 2006/0274894 A1
(43) Pub. Date: Dec. 7, 2006

(54) Method and apparatus for cryptography

(76) Inventors: Ihor Vasyltsov, Suwon-si (KR); Yoo-Jin Baek, yongln-si (KR); Hee-Kwan Son, Suwon-si (KR)

Correspondence Address: HARNESS, DICKEY & PIERCE, P.L.C., P.O. BOX 8910, RESTON, VA, 20195, US

(21) Appl. No.: 11/367,303

(22) Filed: Mar. 6, 2006

(30) Foreign Application Priority Data
Mar. 5, 2005 (KR) 10-2005-0018429

(51) Int. Cl. H04L 9/28

(52) U.S. Cl. 380/28

(57) ABSTRACT

Provided are example embodiments of a cryptographic method and apparatus thereof. The cryptographic method and apparatus may be implemented in Weierstrass and Hessian forms, and for the point representations, Affine, Ordinary Projective, Jacobian Projective, and Lopez-Dahab Projective. The cryptographic method and apparatus may prevent confidential information from leakage by checking faults in a basic point due to certain attacks, faults in definition fields, and faults in elliptic curve (EC parameters before outputting final cryptographic results.

### PRIORITY CLAIM

A claim of priority is made to Korean Patent Application No. 10-2005-0018429, filed on Mar. 5, 2005, in the Korean Intellectual Property Office, the disclosure of which is incorporated herein in its entirety by reference.

### BACKGROUND OF THE INVENTION

1. Field of the Invention

Example embodiments of the present invention generally relate to cryptographic methods and apparatuses.

2. Description of the Related Art

To solve problems with modem confidential data communications, cryptographic systems based on well-known crypto-algorithms have been used. Crypto-algorithms public key algorithms, such as Rivest-Shamir-Adleman (RSA) and Elliptic Curve Cryptography (ECC), and symmetric key algorithms, such as Data Encryption Standard (DES) and Advanced Encryption Standard (AES), are well known.

However, in addition to hardware-oriented crypto-systems, new crypto-analysis methods such as Side-Channel Analysis (SCA) have been developed. There may be several different techniques of attacks, including Timing Analysis, Power Analysis, Electro-Magnetic Analysis, and Different Faults Analysis (DFA). These techniques may successfully attack crypto-systems and obtain secret keys with less time and effort.

Accordingly, the development of counter-measurements against the crypto-analysis methods such as SCA is important. A powerful and dangerous SCA technique is the DFA. However, because the ECC is a relatively new branch of cryptography there is little information and techniques against attacks from the DFA.

FIG. 1 is a block diagram of a cryptographic apparatus 100 of the conventional art. Referring to FIG. 1, the cryptographic apparatus 100 may include a scalar multiplication unit 110 and a comparing and outputting unit 120. The scalar multiplication unit 110 may include parallel ECC operation units 112 and 113. Each of the ECC operation units 112 and 113 may generate an encrypted output point by performing a scalar multiplication operation on an input point P and a secret key according to an ECC algorithm. The comparing and outputting unit 120 may check if the output points generated by the ECC operation units 112 and 113 are the same. If the output points are the same, comparing and outputting unit 120 may transmit any one of the output points Q to a post-processor, or if the output points are not the same, comparing and outputting unit 120 may not transmit the output point Q. That is, if a fault had occurred during the scalar multiplication operation for the encryption, the encrypted output points generated by the ECC operation units 112 and 113 may be different from each other, therefore, the encrypted output points may not be transmitted to the post-processor in order to prevent leakage of confidential information.

To compromise a crypto-system such as a smart card having the cryptographic apparatus 100, a cryptanalyst (attacker) may generate a fault (power glitches, electromagnetic or optical influence) during a scalar multiplication computation, create the same encrypted output points generated by the parallel ECC operation units 112 and 113, and may analyze the faulty output points and obtain a secret key used by the crypto-system. Generally, an attacker may create transient or permanent faults. For example, the transient faults may be generated during a parameter transmission, and the permanent faults may be generated at any location of system parameters. For different elliptic curve (EC) point representations, three types of faults that may be induced during the computation, such as faults in the base point P, faults in definition fields of point P, and faults in EC parameters. The main drawbacks of the conventional art counter-measurement as illustrated in FIG. 1 consist in performance degradation, and high computational costs, which makes them practically useless.

### SUMMARY OF THE INVENTION

In an example embodiment of the present invention, a cryptographic method includes providing elliptic curve (EC) domain parameters, a binary check code (BCC), an input point, and a secret key, determining whether a value calculated based on the EC domain parameters is equal to the BCC, determining whether the input point exists on an elliptic curve (EC) defined by the EC domain parameters, generating an encrypted output point by performing scalar multiplication on the input point and the secret key using the EC domain parameters, determining whether the encrypted output point exists on the EC defined by the EC domain parameters; and outputting the encrypted output point if the value calculated based on the EC domain parameters is equal to the BCC and if the input point and the encrypted output point exist on the EC, and not outputting the encrypted output point if the value calculated based on the EC domain parameters is not equal to the BCC or if the input point or the encrypted output point does not exist on the EC.

In another embodiment of the present invention, a cryptographic method includes providing elliptic curve (EC) domain parameters, a binary check code (BCC), a first input point, and a secret key, generating a second input point using the EC domain parameters and the BCC, generating an encrypted output point by performing scalar multiplication of the second input point and the secret key using the EC domain parameters, generating a first information signal indicating whether the first input point is equal to the second input point re-estimated from the EC domain parameters and the BCC, generating a second information signal indicating whether the encrypted output point exists on an elliptic curve (EC) defined by the EC domain parameters, and performing an XOR operation of the first information signal, the second information signal, and the encrypted output point.

There is also provided in another example embodiment of the present invention, a cryptographic apparatus including a scalar multiplication unit adapted to receive an input point and a secret key, and generate an encrypted output point by performing scalar multiplication using elliptic curve (EC) domain parameters, a domain checker adapted to check whether a value calculated based on the EC domain parameters is equal to a binary check code (BCC), and a point checker adapted to determine whether the input point and the encrypted output point exist on an elliptic curve (EC) defined by the EC domain parameters, wherein, if the value calculated based on the EC domain parameters is equal to the BCC and if the input point and the encrypted output point exist on the EC, the encrypted output point is output, and if the value calculated based on the EC domain parameters is not equal to the BCC or if the input point or the encrypted output point does not exist on the EC, the encrypted output point is not output.

In another embodiment of the present invention, a cryptographic apparatus includes an input point computation circuit adapted to generate a second input point using elliptic curve (EC) domain parameters and a binary check code (BCC), which is a function of a first input point, a scalar multiplication computation circuit adapted to receive the second input point and a secret key and generate an encrypted output point by performing scalar multiplication using the EC domain parameters, a domain checking circuit adapted to generate a first information signal indicating whether the first input point is equal to the second input point estimated from the EC domain parameters and the BCC, and an outputting circuit generating a second information signal indicating whether the encrypted output point exists on the EC and performing an XOR operation of the first information signal, the second information signal, and the encrypted output point.

### BRIEF DESCRIPTION OF THE DRAWINGS

The present invention will become more apparent with the description of the detail example embodiments thereof with reference to the attached drawings in which:

FIG. 1 is a block diagram illustrating a cryptographic apparatus of the conventional art;

FIG. 2 illustrates a hierarchy of a scalar multiplication operation;

FIG. 3 is a flowchart illustrating a cryptographic method according to an example embodiment of the present invention;

FIG. 4 is a block diagram of a cryptographic apparatus implementing the cryptographic method of FIG. 3 according to an example embodiment of the present invention;

FIG. 5 is a block diagram of a cryptographic apparatus implementing the cryptographic method of FIG. 3 according to another example embodiment of the present invention;

FIG. 6 illustrates a domain checker according to an example embodiment of the present invention;

FIG. 7 illustrates a point checker according to an example embodiment of the present invention;

FIG. 8 is a detailed block diagram of a point checker in Weierstrass Affine (WA) coordinates in GF(p) according to an example embodiment of the present invention;

FIG. 9 is a detailed block diagram of a point checker in Weierstrass Ordinary Projective (WP) coordinates in GF(p) according to an example embodiment of the present invention;

FIG. 10 is a detailed block diagram of a point checker in Weierstrass Jacobian Projective (WJ) coordinates in GF(p) according to an example embodiment of the present invention;

FIG. 11 is a detailed block diagram of a point checker in Weierstrass Lopez-Dahab Projective (WL) coordinates in GF(p) according to an example embodiment of the present invention;

FIG. 12 is a detailed block diagram of a point checker in Weierstrass Affine (WA) coordinates in GF(2″) according to an example embodiment of the present invention;

FIG. 13 a detailed block diagram of a point checker in Weierstrass Ordinary Projective (WP) coordinates in GF(2″) according to an example embodiment of the present invention;

FIG. 14 is a detailed block diagram of a point checker in Weierstrass Jacobian Projective (WJ) coordinates in GF(2″) according to an example embodiment of the present invention;

FIG. 15 is a detailed block diagram of a point checker in Weierstrass Lopez-Dahab Projective (WL) coordinates in GF(2″) according to an example embodiment of the present invention;

FIG. 16 is a detailed block diagram of a point checker in Hessian Affine (HA) coordinates according to an example embodiment of the present invention;

FIG. 17 is a detailed block diagram of a point checker in Hessian Ordinary Projective (HP) coordinates according to an example embodiment of the present invention; and

FIG. 18 is a flowchart illustrating a cryptographic method according to another example embodiment of the present invention.

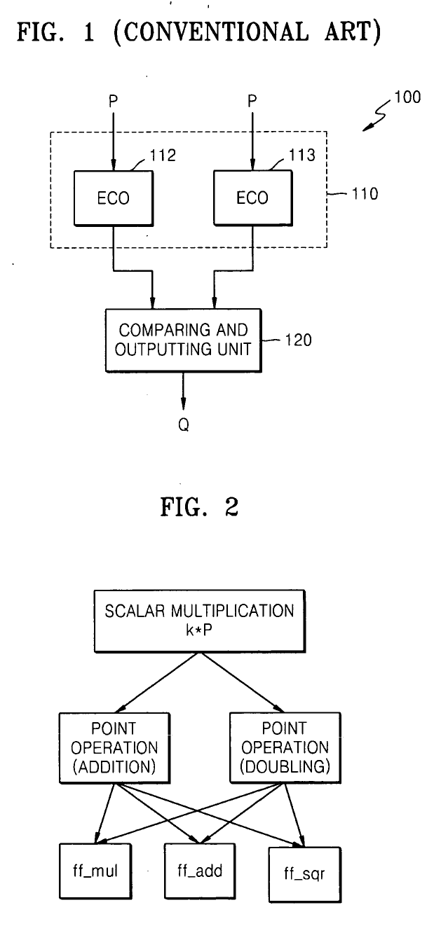

### DETAILED DESCRIPTION OF EXAMPLE EMBODIMENTS OF THE INVENTION

Hereinafter, example embodiments of the present invention will be described with reference to the accompanying drawings. Like reference numbers are used to refer to like elements throughout the drawings.

An elliptic curve E is a set of points (x, y), which satisfy the elliptic curve equation (Equation 1) in the Weierstrass Affine form:
E: y²+a₁xy+a₃y=x³+a₂x²+a₄x+a₆ (1)

For cryptographic applications, the elliptic curve may be used over a prime finite field GF(p) or a binary finite field GF(2″). Here, GF( ) denotes a Galois field, a prime finite field is a field containing a prime number of elements, and a binary finite field is a field containing 2″ elements.

If p is an odd prime number, then there is a unique field GF(p) with p elements. For the prime finite field case, Equation 1 is:

$$\{ \begin{matrix}GF ( p ) , p > 3 \\ {y}^{2} = {x}^{3} + ax + b ; \\ 4 {a}^{3} + 27 {b}^{2} ≢ 0 ( mod p )\end{matrix} \qquad ( 2 )$$

If n≧1, then there is a unique field GF(2″) with 2″ elements. For the binary finite field case, Equation 1 is:

$$\{ \begin{matrix}GF ( {2}^{n} ) \\ {y}^{2} + xy = {x}^{3} + {ax}^{2} + b ; \\ b \neq 0\end{matrix} \qquad ( 3 )$$

The elliptic curves may have the point addition operation, and in special circumstance the point doubling operation may occur in the following. To get the resulted point R=P+Q=(x₃,y₃) from two points P=(x₁, y₁) and Q=(x₂,y₂), a next finite field operation (Equation 4) operation is requested GF(p):

$$P \neq Q ⇒ \{ \begin{matrix}θ = \frac{{y}_{2} - {y}_{1}}{{x}_{2} - {x}_{1}} ; \\ {x}_{3} = {θ}^{2} - {x}_{1} - {x}_{2} ; \\ {y}_{3} = θ ( {x}_{1} - {x}_{3} ) - {y}_{1} ;\end{matrix} \qquad ( 4 )$$

When it is the point doubling operation (P=Q), then the next finite field operation (Equation 5) may be performed in GF(p):

$$P = Q ⇒ \{ \begin{matrix}θ = \frac{3 {x}^{2} + a}{ 2 y} ; \\ {x}_{3} = {θ}^{2} - 2 x ; \\ {y}_{3} = θ ( x - {x}_{3} ) - y ;\end{matrix} \qquad ( 5 )$$

Equations 4 and 5 may be the same as Equations 6 and 7 in the case of the binary finite field GF(2″)

$$\begin{matrix}P \neq Q ⇒ \{ \begin{matrix}θ = \frac{{y}_{2} + {y}_{1}}{{x}_{2} + {x}_{1}} ; \\ {x}_{3} = {θ}^{2} + θ + {x}_{1} + {x}_{2} + a ; \\ {y}_{3} = θ ( {x}_{1} + {x}_{3} ) + {x}_{3} + {y}_{1} ;\end{matrix} & ( 6 ) \\ P = Q ⇒ \{ \begin{matrix}θ = x + \frac{y}{x} ; \\ {x}_{3} = {θ}^{2} + θ + a ; \\ {y}_{3} = θ ( x + {x}_{3} ) + {x}_{3} + y ;\end{matrix} & ( 7 )\end{matrix}$$

The main operation in the ECC may be a scalar point multiplication, which comprises of computing Q=k·P=P+P+. . . +P (k times), where k is a secret key. As shown in the hierarchy illustrated in FIG. 2, the scalar point multiplication may be based on the point operations, which in turn may be based on the finite field operations, ff_mul (multiplication in finite field), ff_add (addition in finite field) and ff_sqr (square in finite field). A related operation may be the discrete logarithm, which comprises of computing k from P and Q=k·P.

There may be different possible representations of the point (dot) on the elliptic curve besides the Affine representation (used in the above equations), for example, Ordinary Projective, Jacobian Projective, and Lopez-Dahab Projective. Each of the representations has advantages, for example, better performance, resistance to some kind of attacks, and/or easy-to-build system.

In the Ordinary Projective (WP) coordinates in GF(p), Equation 1 may be written as Equation 8. The relationship between Equations 1 and 8 may be illustrated in Equation 9.

$$\begin{matrix}{Y}^{2} Z = {X}^{3} + {aXZ}^{2} + {bZ}^{3} , & ( 8 ) \\ \{ \begin{matrix}P ( x , y ) {{{\underbrace{⇒}}_{X = x}}_{Y = y}}_{Z = 1} P ( X , Y , Z ) \\ P ( X , Y , Z ) {{\underbrace{⇒}}_{x = \frac{X}{Z}}}_{y = \frac{Y}{Z}} P ( x , y )\end{matrix} & ( 9 )\end{matrix}$$

In Jacobian Projective (WJ) coordinates in GF(p), Equation 1 may be written as Equation 10. The relationship between Equations 1 and 10 may be illustrated as Equation 11.

$$\begin{matrix}{Y}^{2} = {X}^{3} + {aXZ}^{4} + {bZ}^{6} , & ( 10 ) \\ \{ \begin{matrix}P ( x , y ) {{{\underbrace{⇒}}_{X = x}}_{Y = y}}_{Z = 1} P ( X , Y , Z ) \\ P ( X , Y , Z ) {{\underbrace{⇒}}_{x = \frac{X}{{Z}^{2}}}}_{y = \frac{Y}{{Z}^{3}}} P ( x , y )\end{matrix} & ( 11 )\end{matrix}$$

In Lopez-Dahab Projective coordinates in GF(p), Equation 1 may be written as Equation 12. The relationship between Equations 1 and 12 may be illustrated as Equation 13.

$$\begin{matrix}{Y}^{2} = {X}^{3} Z + {aXZ}^{3} + {bZ}^{4} & ( 12 ) \\ \{ \begin{matrix}P ( x , y ) {{{\underbrace{⇒}}_{X = x}}_{Y = y}}_{Z = 1} P ( X , Y , Z ) \\ P ( X , Y , Z ) {{\underbrace{⇒}}_{x = \frac{X}{Z}}}_{y = \frac{Y}{{Z}^{2}}} P ( x , y )\end{matrix} & ( 13 )\end{matrix}$$

In Ordinary Projective coordinates in GF(2″), Equation 1 may be written as Equation 14. The relationship between Equations 1 and 14 may be illustrated as Equation 15.

$$\begin{matrix}{Y}^{2} Z + XYZ = {X}^{3} + {aX}^{2} Z + {bZ}^{3} & ( 14 ) \\ \{ \begin{matrix}P ( x , y ) {{{\underbrace{⇒}}_{X = x}}_{Y = y}}_{Z = 1} P ( X , Y , Z ) \\ P ( X , Y , Z ) {{\underbrace{⇒}}_{x = \frac{X}{Z}}}_{y = \frac{Y}{Z}} P ( x , y )\end{matrix} & ( 15 )\end{matrix}$$

In Jacobian Projective coordinates in GF(2″), Equation 1 may be written as Equation 16. The relationship between Equations 1 and 16 may be illustrated as Equation 17.

$$\begin{matrix}{Y}^{2} Z + XYZ = {X}^{3} + {aX}^{2} {Z}^{2} + {bZ}^{6} & ( 16 ) \\ \{ \begin{matrix}P ( x , y ) {{{\underbrace{⇒}}_{X = x}}_{Y = y}}_{Z = 1} P ( X , Y , Z ) \\ P ( X , Y , Z ) {{\underbrace{⇒}}_{x = \frac{X}{{Z}^{2}}}}_{y = \frac{Y}{{Z}^{3}}} P ( x , y )\end{matrix} & ( 17 )\end{matrix}$$

In Lopez-Dahab Projective coordinates in GF(2″), Equation 1 may be written as Equation 18. The relationship between Equations 1 and 18 may be illustrated as Equation 19.

$$\begin{matrix}{Y}^{2} + XYZ = {X}^{3} Z + {aX}^{2} {Z}^{2} + {bZ}^{4} & ( 18 ) \\ \{ \begin{matrix}P ( x , y ) \underbrace{⇒}_{{X = x}_{{Y = y}_{Z = 1}}} P ( X , Y , Z ) \\ P ( X , Y , Z ) \underbrace{⇒}_{{x = \frac{X}{Z}}_{y = \frac{Y}{{Z}^{2}}}} P ( x , y )\end{matrix} & ( 19 )\end{matrix}$$

The Weierestrass form of the elliptic curve representation is the most commonly used form in the cryptographic application, but recently the Hessian form, which may be characterized by the possibility of parallelization as well as advantages in SCA-resistant implementations, has also been used. In the Hessian Affine coordinates, Equation 1 may be written as Equation 20. The relationship between the Weierestrass form and the Hessian form may be illustrated as Equation 21. To move from Equation 1 to Equation 21 and vice versa, rules described in Equation 22 applies.

$$\begin{matrix}E \text{:} {u}^{3} + {v}^{3} + 1 = Duv , D ∈ K , {D}^{3} \neq 1 & ( 20 ) \\ \{ \begin{matrix}{E}_{H} \text{:} {u}^{3} + {v}^{3} + 1 = Duv \\ {E}_{W} \text{:} {y}^{2} = {x}^{3} - 27 D ( {D}^{3} + 8 ) x + 54 ( {D}^{6} - 20 {D}^{3} - 8 ) \\ {E}_{W} ⇔ {E}_{H}\end{matrix} & ( 21 ) \\ \{ \begin{matrix}P ( x , y ) \underbrace{⇒}_{\begin{matrix}\begin{matrix}u = η ( x + 9 {D}^{2} ) \\ v = - 1 + η ( 3 {D}^{3} - Dx - 12 )\end{matrix} \\ η = \frac{6 ( {D}^{3} - 1 ) ( y + 9 {D}^{3} - 3 Dx - 36 )}{{( x + 9 {D}^{2} )}^{3} + {( 3 {D}^{3} - Dx - 12 )}^{3}}\end{matrix}} P ( u , v ) \\ P ( u , v ) \underbrace{⇒}_{\begin{matrix}\begin{matrix}x = - 9 {D}^{2} + ξ u \\ y = 3 ξ ( v - 1 )\end{matrix} \\ ξ = \frac{12 ( {D}^{3} - 1 )}{Du + v + 1}\end{matrix}} P ( x , y )\end{matrix} & ( 22 )\end{matrix}$$

In the Hessian Ordinary Projective coordinates, Equation 1 may be written as Equation 23. The relationship between Affine and Ordinary Projective coordinates in the Hessian form is similar to the Weierstrass form as illustrated in Equation 24.

$$\begin{matrix}{U}^{3} + {V}^{3} + {W}^{3} = DUVW , D ∈ K , {D}^{3} \neq 1 & ( 23 ) \\ \{ \begin{matrix}P ( u , v ) \underbrace{⇒}_{{U = u}_{{V = v}_{W = 1}}} P ( U , V , W ) \\ P ( U , V , W ) \underbrace{⇒}_{{u = \frac{U}{W}}_{v = \frac{U}{W}}} P ( u , v )\end{matrix} & ( 24 )\end{matrix}$$

An attacker may generate a fault (power glitches, electro-magnetic or optical influence) during a scalar multiplication computation, analyzes faulty output data, and may obtain a secret key used by a system. For different EC point representations, three types of faults that may be induced during the computation process may be considered, such as faults in the base point, faults in definition fields, and faults in EC parameters.

Hereinafter, for transient or permanent faults that may exist as DFA attack faults, counter-measurements to prevent confidential information leakage will be described.

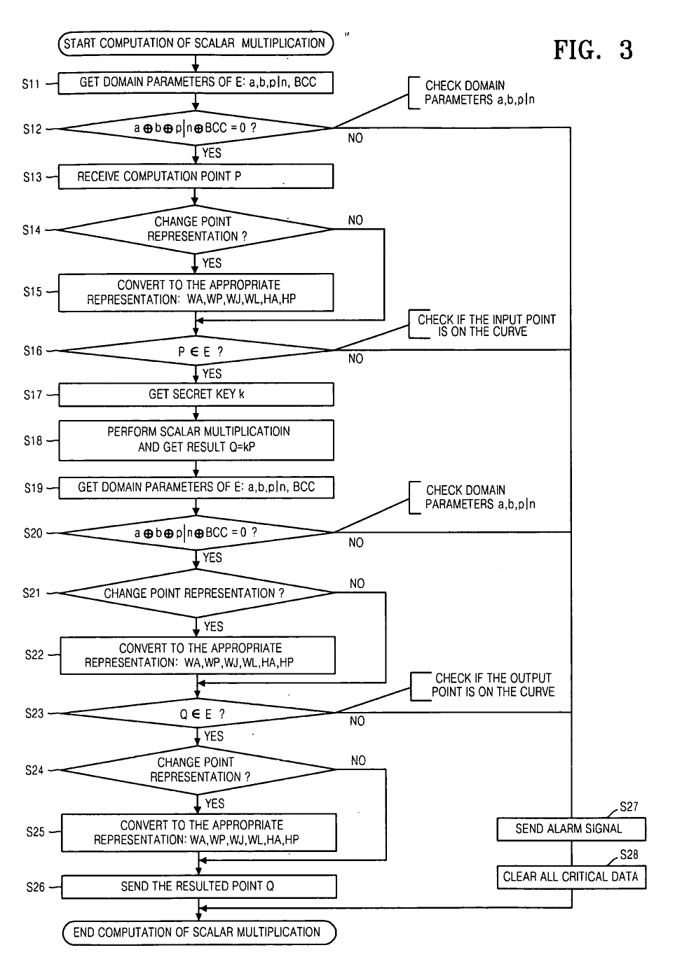

To counter the three type of DFA attacks and combinations thereof, four basic checking operations may be performed, that is, checking EC domain parameters at an input (before the scalar multiplication operation), checking an input point P at the input, checking the EC domain parameters at the output (after the scalar multiplication operation), and checking an encrypted output point Q=k·P at the output. An example embodiment will be described in more detail with reference to FIG. 3.

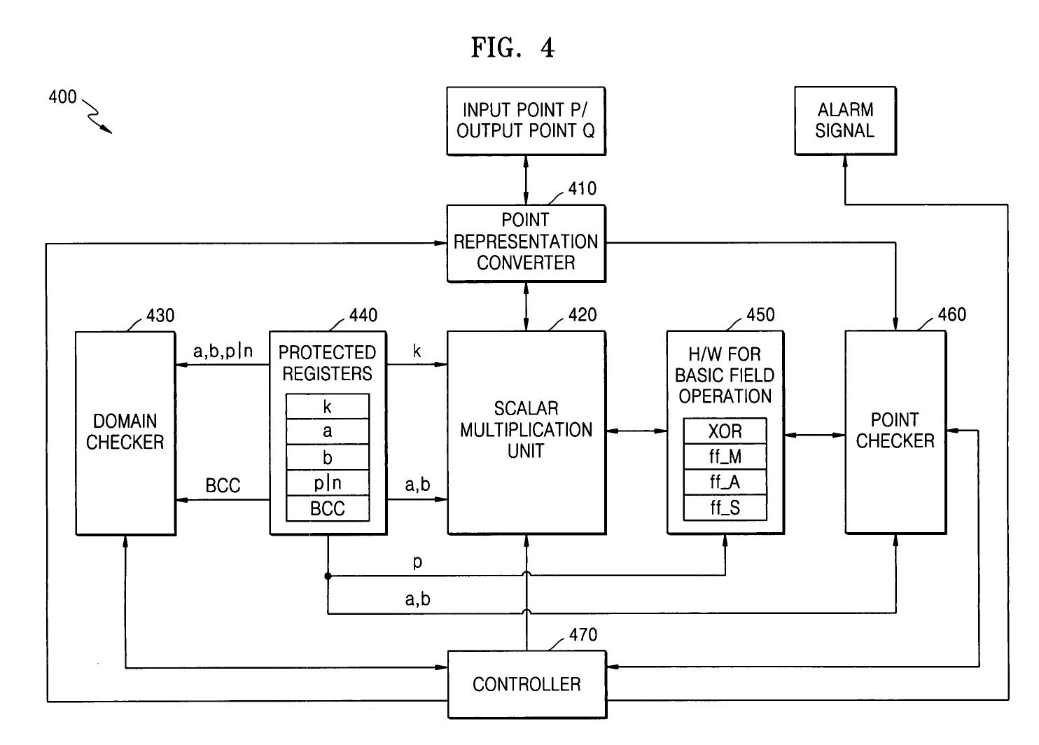

FIG. 3 is a flowchart illustrating a scalar multiplication operation to encrypt an input point P according to an example embodiment of the present invention. Referring to FIG. 3, a scalar multiplication unit (420 of FIG. 4) may receive EC domain parameters and binary check code (BCC) from a protected non-volatile memory (440 of FIG. 4) in operation S11. Here, the domain parameters may be a,b,p in the case of GF(p) and a,b,n in the case of GF(2″). In operation S12, a domain checker (430 of FIG. 4) may check if a value a⊕b⊕p|n calculated using the EC domain parameters is equal to the BCC. If the value a⊕b⊕p|n calculated using the EC domain parameters is equal to the BCC, the operation may proceed to the next operation, but if they are not equal, an alarm signal may be sent out in operation S27, and all critical information, e.g., all data in the scalar multiplication operation may be erased from a public memory in operation S28.

To check the domain parameters in operation S12, an XOR (Exclusive OR) device illustrated in FIG. 6 may be used. Here, the BCC may be defined by Equation 25 and may be stored in the non-volatile memory (440 of FIG. 4).
BCC=a⊕b⊕p|n (25)

If the BCC is equal to the value a⊕b⊕p|n calculated using the EC domain parameters, the value checked by an XOR operation of Equation 26 is 0.
a⊕b⊕p|n⊕BCC=0 (26)

For the domain parameters stored in the protected non-volatile memory (440 of FIG. 4), an attacker may induce only random faults, and thus the possibility of inducing faults required to analyze all of the BCC values and other domain parameters a,b,p|n may be negligible.

The scalar multiplication unit (420 of FIG. 4) may receive the input point P from the outside in operation S13. If necessary, the input point P may be converted to a requested point representation, e.g., WA—Weierstrass Affine, WP—Weierstrass Ordinary Projective, WJ—Weierstrass Jacobian Projective, WL—Weierstrass Lopez-Dahab Projective, HA—Hessian Affine, or HP—Hessian Ordinary Projective, according to Equations 8 through 24 in operations S14 and S15. The conversion may be performed by a point representation converter (410 of FIG. 4).

A point checker (460 of FIG. 4) may check if the input point P exists on an EC defined by the domain parameters in operation S16. Here, if the input point P exists on the EC, the operation may proceed to the next operation, and if the input point P does not exist, an alarm signal may be sent out in operation S27, and all critical information may be erased from the public memory in operation S28.

The scalar multiplication unit (420 of FIG. 4) may receive a secret key k in operation S17 and generate an encrypted output point Q=k·P by performing the scalar multiplication on the input point P and the secret key k using the EC domain parameters in operation S18. If the input point P had been converted to another point representation in operation S15, a corresponding encrypted output point Q=k·P may be generated from the point-converted input point.

Checking the EC domain parameters and the encrypted output point Q=k·P at the output may be performed in the same way.

The domain checker (430 of FIG. 4) may receive the EC domain parameters in operation S19, and in operation S20, the domain checker 430 may check if a value a⊕b⊕p|n calculated using the EC domain parameters is equal to the BCC in the same manner as in operation S12. If the value a⊕b⊕p|n is equal to the BCC, the operation may proceed to the next operation, but if the values are not equal, an alarm signal may be sent out in operation S27, and all critical information, e.g., all data in the scalar multiplication operation may be erased from the public memory in operation S28. Here, similar to operation S15, if necessary, the encrypted output point Q=k·P may be converted to another point representation by the point representation converter (410 of FIG. 4) according to Equations 8 through 24 in operations S21 and S22.

The point checker (460 of FIG. 4) may check if the encrypted output point Q=k·P exists on the EC defined by the domain parameters in operation S23. Here, if the encrypted output point Q=k·P exists on the EC, the operation may proceed to the next operation, but if it does not exist, an alarm signal may be sent out in operation S27, and all critical information may be erased from the public memory in operation S28. If necessary, the encrypted output point Q=k·P may be converted again to another point representation by the point representation converter (410 of FIG. 4) according to Equations 8 through 24 in operations S24 and S25. According to operations S11 through S25, if the value a⊕b⊕p|n calculated using the EC domain parameters is equal to the BCC and if the input point P and the encrypted output point Q=k·P exist on the EC, the encrypted output point Q=k·P may be output to a post-processor of an upper layer in operation S26.

FIG. 4 is a block diagram of a cryptographic apparatus 400 implementing the cryptographic method of FIG. 3 according to an example embodiment of the present invention. Referring to FIG. 4, the cryptographic apparatus 400 may include the point representation converter 410, the scalar multiplication unit 420, the domain checker 430, the protected non-volatile memory 440, a basic field operation hardware 450, the point checker 460, and a controller 470.

The controller 470 may control the entire system to implement the cryptographic method of FIG. 3. The protected non-volatile memory 440 may store and provide the EC domain parameters, the BCC, and the secret key k under the control of the controller 470 (operations S11, S17, and S19 of FIG. 3).

The scalar multiplication unit 420 may receive the input point P and the secret key k and generate the encrypted output point Q=k·P by performing the scalar multiplication using the domain parameters a,b,p|n (operation S18 of FIG. 3). The basic field operation hardware 450 may include an XOR device, a multiplier ff_M, an adder ff_A, and a subtractor ff_S, which may be used for the scalar multiplication performed by the scalar multiplication unit 420.

The domain checker 430 may check if the value a⊕b⊕p|n calculated using the EC domain parameters is equal to the BCC (operations S12 and S20 of FIG. 3). The domain checker 430 may check the above result before and after the generation of the encrypted output point Q=k·P and may determine whether the result is 0 as illustrated in Equation 26 using an XOR device.

The point checker 460 may check if the input point P and the encrypted output point Q=k·P exist on the EC (operations S16 and S23 of FIG. 3).

The point representation converter 410 may convert the input point P to another point representation (WA, WP, WJ, WL, HA, or HP) (S15, S22, and S25 of FIG. 3). Here, if the input point P is converted to another point representation, the scalar multiplication unit 420 may generate the encrypted output point Q=k·P from the point-converted input point (operation S18 of FIG. 3).

Likewise, according to operations S11 through S25 of FIG. 3, if the value a⊕b⊕p|n calculated using the EC domain parameters is equal to the BCC and if the input point P and the encrypted output point Q=k·P exist on the EC, the cryptographic apparatus 400 of FIG. 4 may output the encrypted output point Q=k·P to the post-processor in the upper layer (S26 of FIG. 3).

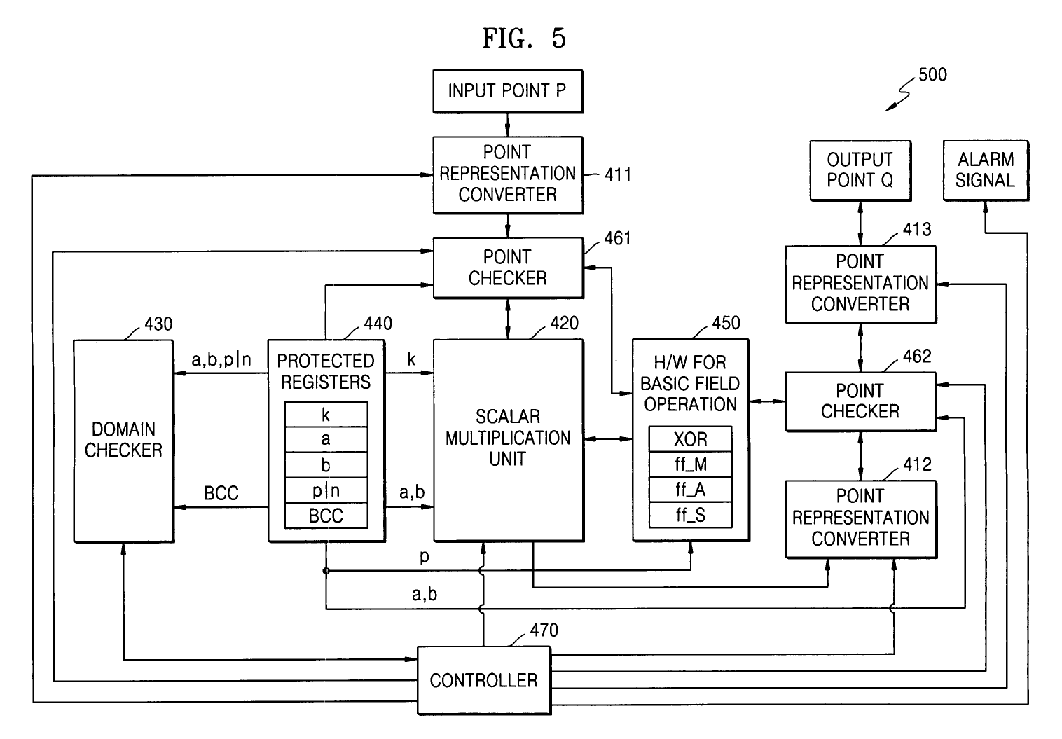

FIG. 5 is a block diagram of a cryptographic apparatus 500 implementing the cryptographic method of FIG. 3 according to another example embodiment of the present invention. The cryptographic apparatus 500 may have a similar configuration and may perform similar operations as the scalar multiplication unit 420, the domain checker 430, the protected non-volatile memory 440, the basic field operation hardware 450, and the controller 470 of FIG. 4. Also, for maximum operational performance, the cryptographic apparatus 500 may include a first point representation converter 411, a second point representation converter 412, and a third point representation converter 413 instead of the single point representation converter 410 of FIG. 4. The cryptographic apparatus 500 may further include a first point checker 461 and a second point checker 462 in addition to the single point checker 460 of FIG. 4.

Unlike the point representation converter 410 of FIG. 4, which may share the input point to convert it to another point representation (WA, WP, WJ, WL, HA, or HP) in each of operations S15, S22 and S25, the first point representation converter 411, the second point representation converter 412, and the third point representation converter 413 may convert points input in operations S15, S22 and S25 to other point representations (WA, WP, WJ, WL, HA, or HP), respectively.

In more detail, the point representation converter 410 of FIG. 4 may convert the input point P to another point presentation in S15, may convert the encrypted output point Q=k·P generated by the scalar multiplication unit 420 to another point presentation in operation S22, and also may convert the encrypted output point Q=k·P to another point presentation in operation S25 after it is checked if the encrypted output point Q=k·P exists on the EC. However, the first point representation converter 411 of FIG. 5 may convert the input point P to another point presentation in operation S15, the second point representation converter 412 may convert the encrypted output point Q=k·P generated by the scalar multiplication unit 420 to another point presentation in S22 of FIG. 3, and the third point representation converter 413 may also convert the encrypted output point Q=k·P to another point presentation in S25 after it is checked if the encrypted output point Q=k·P exists on the EC.

Also, unlike the point checker 460 of FIG. 4, which checks if the input point P and the encrypted output point Q=k·P exist on the EC in operations S16 and S23, the first point checker 461 may check if the input point P exists on the EC in operation S16 and the second point checker 462 checks if the encrypted output point Q=k·P exists on the EC in operation S23, respectively.

An attacker still has another DFA attack PA defined by Equation 27. Here, P_{SM} indicates the probability of inducing faults requested by the attacker in the scalar multiplication operation, and P_{C} indicates the probability to induce faults requested by the point checker(s):
P_{A}=P_{SM}·P_{C}. (27)

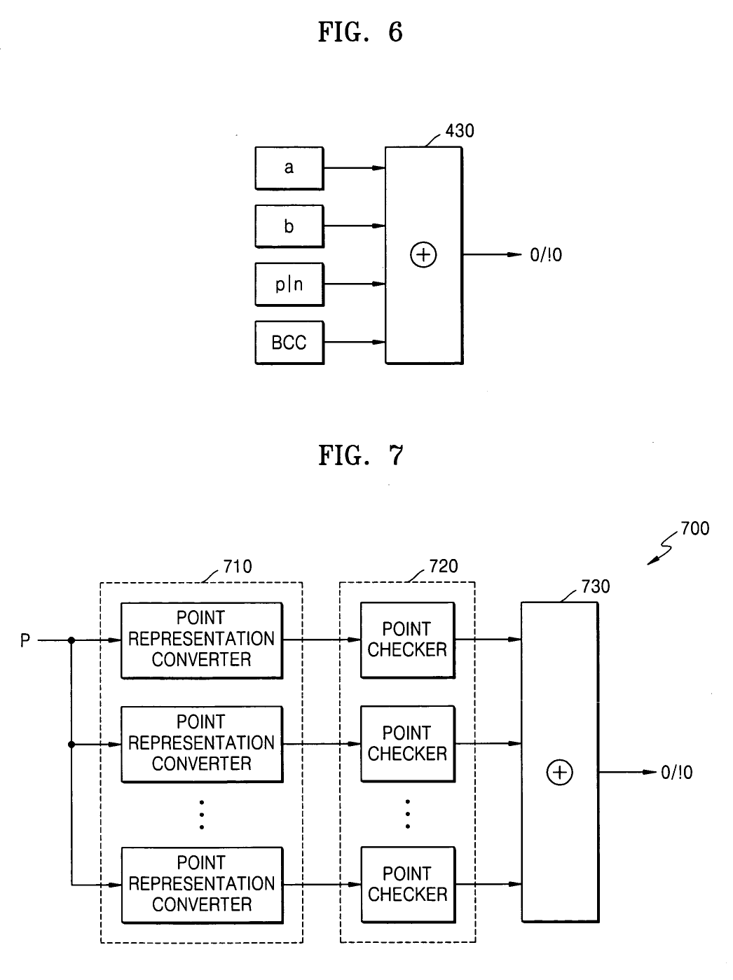

To decrease P_{C} of Equation 27, an example embodiment of the present invention is illustrated in FIG. 7 as a point checking device 700, which may be applied to operations S16 and S23. Referring to FIG. 7, the point checking device 700 may include a point checker 720 having a plurality of odd number unit point checking elements and an XOR device 730, and may further include an optional point representation converter 710 having the same number of unit point representation converting elements as the unit point checking elements.

Similar to point checker 460 of FIG. 4 and point checkers 461 and 462 of FIG. 5, each of the unit point checking elements included in the point checker 720 may check if the input point P exists on the EC. The XOR device 730 may output a result obtained by performing an XOR operation of outputs of the unit point checking elements 720. According to the characteristic of the XOR operation, it may be preferable that the number of unit point checking elements included in the point checker 720 may be an odd number. The number of the optionally applicable unit point representation converting elements included in the point representation converter 710 correspond one to one to the number of unit point checking elements included in the point checker 720. Each unit point representation converting element may convert the input point to another point representation and may output the converted point representation to each relevant unit point checking element.

The total DFA attack possibility P_{A} may decrease as defined in Equation 28. Here, P_{C} indicates the probability to induce faults in each of the unit point checking elements 720, and t indicates the number of unit point checking elements 720.

$${P}_{A} = {P}_{SM} \cdot {\prod }_{i = 1}^{t} {P}_{C} \qquad ( 28 )$$

Detailed circuits of the point checker 460 of FIG. 4 or 461 and 462 of FIG. 5 will now be described.

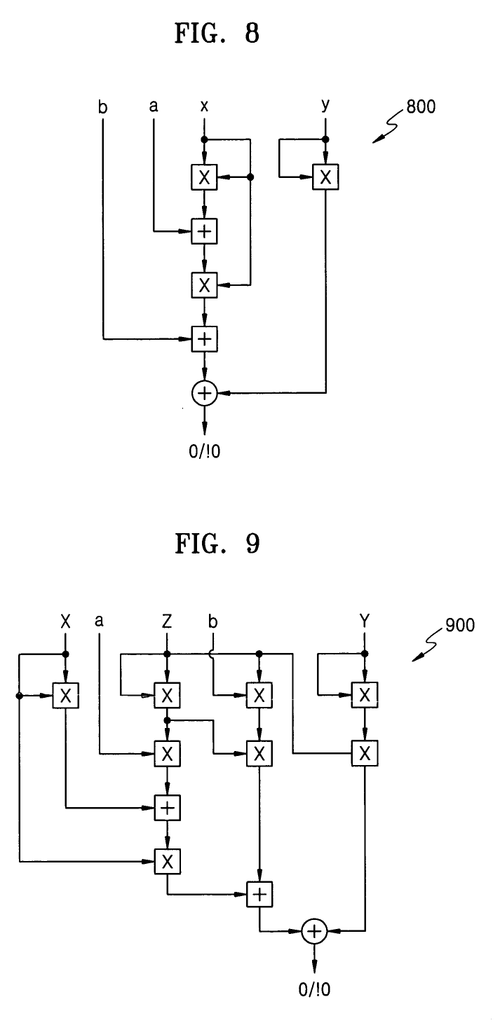

FIG. 8 is a detailed block diagram of a point checker 800 in Weierstrass Affine (WA) coordinates in GF(p). The point checker 800 may check Equation 2 in order to check if an input point exists on an EC. That is, the point checker 800 may check “x³+ax+b” and “y²” of Equation 2 by performing three multiplications and two additions, perform an XOR operation of the calculated values, and may output the result 0/!0 of the XOR operation. Here, (x, y) may be the input point, and a and b may be relevant EC parameters.

FIG. 9 is a detailed block diagram of a point checker 900 in Weierstrass Ordinary Projective (WP) coordinates in GF(p). The point checker 900 may check Equation 8 in order to check if an input point exists on an EC. That is, the point checker 900 may check “X³+aXZ²+bZ³” and “Y²Z” of Equation 8 by performing eight multiplications and two additions, perform an XOR operation of the calculated values, and may output the result 0/!0 of the XOR operation. Here, (X, Y, Z) may be the input point, and a and b may be relevant EC parameters.

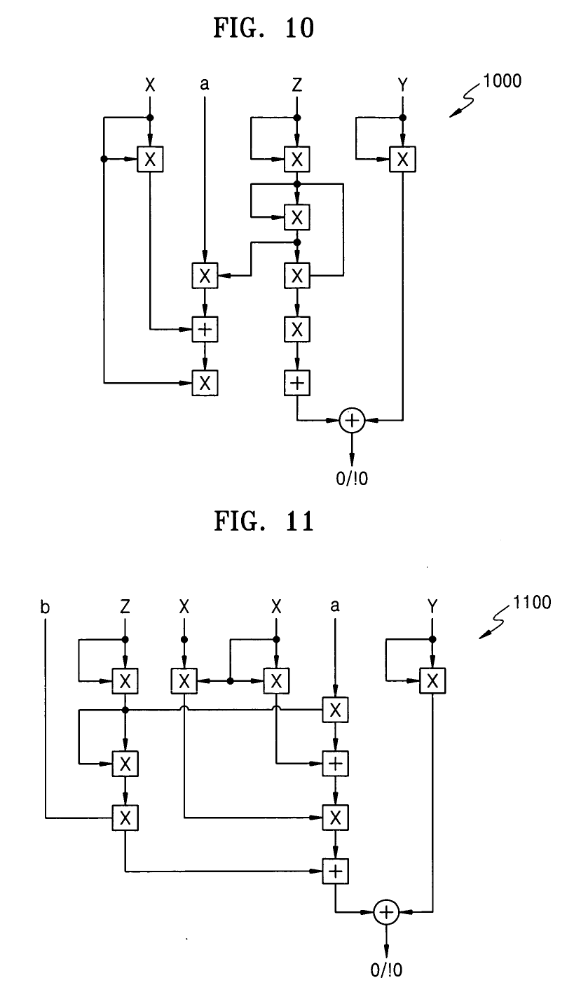

FIG. 10 is a detailed block diagram of a point checker 1000 in Weierstrass Jacobian Projective (WJ) coordinates in GF(p). The point checker 1000 may check Equation 10 in order to check if an input point exists on an EC. That is, the point checker 1000 may check “X³+aXZ⁴+bZ⁶” and “Y²” of Equation 10 by performing eight multiplications and two additions, perform an XOR operation of the calculated values, and may output the result 0/!0 of the XOR operation. Here, (X, Y, Z) may be the input point, and a and b may be relevant EC parameters.

FIG. 11 is a detailed block diagram of a point checker 1100 in Weierstrass Lopez-Dahab Projective (WL) coordinates in GF(p) The point checker 1100 may check Equation 12 in order to check if an input point exists on an EC. That is, the point checker 1100 may check “X³Z+aXZ³+bZ⁴” and “Y²” of Equation 12 by performing eight multiplications and two additions, perform an XOR operation of the calculated values, and may output the result 0/!0 of the XOR operation. Here, (X, Y, Z) may be the input point, and a and b may be relevant EC parameters.

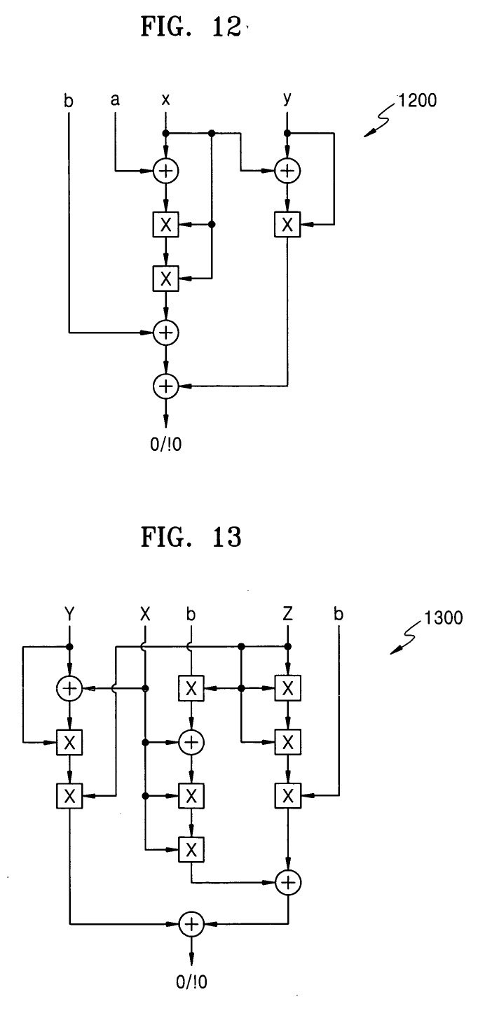

FIG. 12 is a detailed block diagram of a point checker 1200 in Weierstrass Affine (WA) coordinates in GF(2″) The point checker 1200 may check Equation 3 in order to check if an input point exists on an EC. That is, the point checker 1200 may check “x³+ax²+b” and “y²+xy” of Equation 3 by performing three multiplications and three additions, perform an XOR operation of the calculated values, and may output the result 0/!0 of the XOR operation. Here, (x, y) may be the input point, and a and b may be relevant EC parameters.

FIG. 13 a detailed block diagram of the point checker in Weierstrass Ordinary Projective (WP) coordinates in GF(2″) The point checker 1300 may check Equation 14 in order to check if an input point exists on an EC. That is, the point checker 1300 may check “X³Z+aX²Z+bZ³” and “Y²Z+XYZ” of Equation 14 by performing eight multiplications and three additions, perform an XOR operation of the calculated values, and may output the result 0/!0 of the XOR operation. Here, (X, Y, Z) may be the input point, and a and b may be relevant EC parameters.

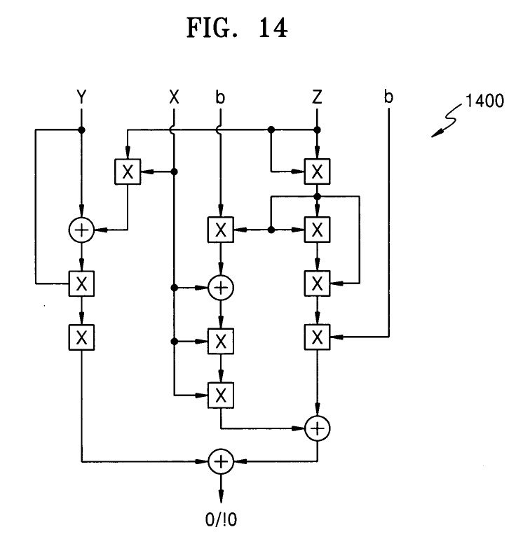

FIG. 14 is a detailed block diagram of a point checker 1400 in Weierstrass Jacobian Projective (WJ) coordinates in GF(2″) The point checker 1400 may check Equation 16 in order to check if an input point exists on an EC. That is, the point checker 1400 may check “X³+aX²Z²+bZ⁶” and “Y²+XYZ” of Equation 16 by performing nine multiplications and three additions, perform an XOR operation of the calculated values, and may output the result 0/!0 of the XOR operation. Here, (X, Y, Z) may be the input point, and a and b may be relevant EC parameters.

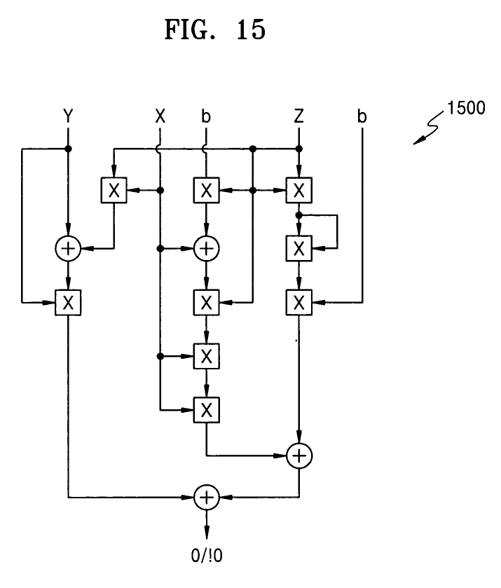

FIG. 15 is a detailed block diagram of the point checker in Weierstrass Lopez-Dahab Projective (WL) coordinates in GF(2″) The point checker 1500 may check Equation 18 in order to check if an input point exists on an EC. That is, the point checker 1500 may check “X³Z+aX²Z²+bZ⁴” and “Y²+XYZ” of Equation 18 by performing nine multiplications and three additions, perform an XOR operation of the calculated values, and may output the result 0/!0 of the XOR operation. Here, (X, Y, Z) may be the input point, and a and b may be relevant EC parameters.

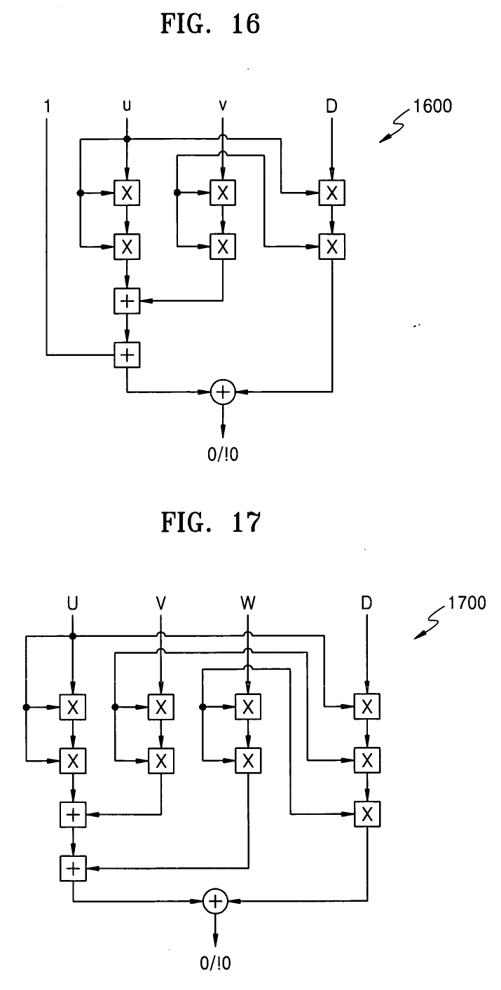

FIG. 16 is a detailed block diagram of a point checker 1600 in Hessian Affine (HA) coordinates. The point checker 1600 may check Equation 20 in order to check if an input point exists on an EC. That is, the point checker 1600 may check “u³+v³+1” and “Duv” of Equation 20 by performing six multiplications and two additions, perform an XOR operation of the calculated values, and may output the result 0/!0 of the XOR operation. Here, u and v may be function of the input point (x, y) and D, and D may be an EC parameter.

FIG. 17 is a detailed block diagram of a point checker 1700 in Hessian Ordinary Projective (HP) coordinates. The point checker 1700 may check Equation 23 in order to check if an input point exists on an EC. That is, the point checker 1700 may check “U³+V³+W³” and “DUVW” of Equation 23 by performing nine multiplications and two additions, perform an XOR operation of the calculated values, and may output the result 0/!0 of the XOR operation. Here, U, V and W may be functions of the input point (x, y) and D, and D may be an EC parameter.

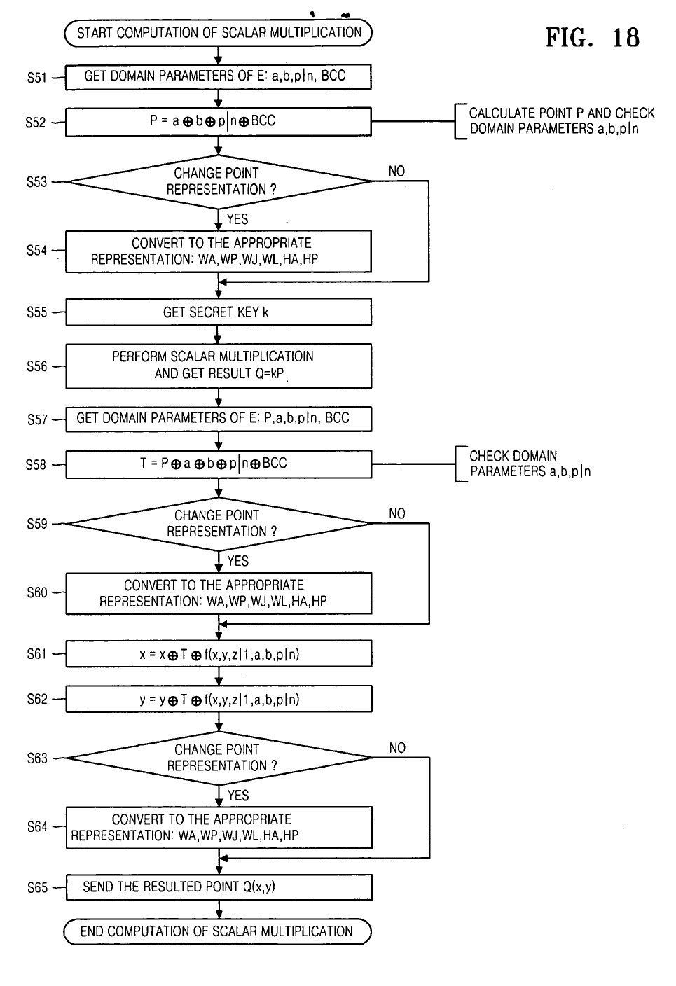

Another example embodiment of a cryptographic method as shown in FIG. 18 may be suggested to solve branch errors that may be generated when a system operates according to whether results determined by the domain checker 430 and the point checker 460 in which the determining operations S12, S16, S20, and S23 of FIG. 3 are performed, respectively, are 0 or !0 (non-zero).

Referring to FIG. 18, a scalar multiplication computation circuit may receive EC domain parameters and BCC from a protected non-volatile memory in operation S51. Here, the domain parameters may be a,b,p in the case of GF(p) and a,b,n in the case of GF(2″) In operation S52, an input point computation circuit may estimate an input point using the EC domain parameters and the BCC in order to check the EC domain parameters.

The BCC may be defined as a function of the input point P as shown in Equation 29 and may be stored in the protected non-volatile memory. Here, BCC may denote the binary check code, P may denote the input point, and a,b,p|n may denote the EC domain parameters where a,b,p may be applied to the case of GF(p) and a,b,n may be applied to the case of GF(241 ).
BCC=P⊕a⊕b⊕p|n (29)

Accordingly, the input point computation circuit may estimate an input point by calculating Equation 30, and if there are no faults in the BCC and the EC domain parameters, the estimated input point P′ calculated by Equation 30 may be equal to the input point P received from the protected non-volatile memory.
P+a⊕b⊕p|n⊕BCC (30)

If necessary, the input point P′ estimated in operation S52 may be converted to another point representation, i.e., WA—Weierstrass Affine, WP—Weierstrass Ordinary Projective, WJ—Weierstrass Jacobian Projective, WL—Weierstrass Lopez-Dahab Projective, HA—Hessian Affine, or HP—Hessian Ordinary Projective, according to Equations 8 through 24 in operations S53 and S54. This operation may be performed by a point representation conversion circuit.

The scalar multiplication computation circuit may receive a secret key k from the protected non-volatile memory in operation S55 and may generate an encrypted output point Q=k·P′ by performing the scalar multiplication of the estimated input point P′ and the secret key k using the EC domain parameters in operation S56. If the estimated input point P′ had been converted to another point representation in operation 54, a relevant encrypted output point Q=k·P may be generated from the point-converted input point.

Checking the EC domain parameters and the encrypted output point Q=k·P at the output (after the scalar multiplication) may be performed in the similar way.

A domain checking circuit may receive the input point P to be encrypted, the EC domain parameters and the BCC from the protected non-volatile memory in operation S57, and may generate a first information signal T indicating whether the received protected non-volatile memory is equal to the input point P′ re-estimated from the EC domain parameters and the BCC in operation S58. The first information signal T may be defined in Equation 31 and may be generated by an XOR operation.
T=P⊕a⊕b⊕p|n⊕BCC (31)

Here, like operation S54, if necessary, the encrypted output point Q=k·P′ may be converted to another point representation by the point representation conversion circuit according to Equations 8 through 24 in operations S59 and S60.

An outputting circuit may check if the encrypted output point Q=k·P′ exists on the EC defined by the EC domain parameters in operations S61 and S62. The outputting circuit may generate a second information signal f indicating whether the encrypted output point Q=k·P′ exists on the EC according to each function definition shown in Table 1 in which point representations may be based on the above equations.

TABLE 1

| Point representation | Function definition f(x, y, z\|1, a, b, p\|n) |
|---|---|
| WA - GF(p) | y² ⊕ (x³ + ax + b) |
| WP - GF(p) | Y²Z ⊕ (X³ + aXZ² + bZ³) |
| WJ - GF(p) | Y² ⊕ (X³ + aXZ⁴ + bZ⁶) |
| WL - GF(p) | Y² ⊕ (X³Z + aXZ³ + bZ⁴) |
| WA - GF(2ⁿ) | (y² + xy) ⊕ (x³ + ax² + b) |
| WP - GF(2ⁿ) | (Y²Z + XYZ) ⊕ (X³ + aX²Z + bZ³) |
| WJ - GF(2ⁿ) | (Y² + XYZ) ⊕ (X³ + aX²Z² + bZ⁶) |
| WL - GF(2ⁿ) | (Y² + XYZ) ⊕ (X³Z + aX²Z² + bZ⁴) |
| HA | (u³ + v³ + 1) ⊕ Duv |
| HP | (U³ + V³ + W³) ⊕ DUVW |

x=x⊕T⊕f(x, y, z|1,a, b, p|n) (32)
y=y⊕T⊕f(x, y, z|1,a, b, p|n) (33)

The outputting circuit may perform XOR operations defined in Equations 32 and 33 using the first information signal T, the second information signal f, and the encrypted output point Q(x, y), and may output the results thereof. According to operations S51 through S64, if there are no faults and the encrypted output point Q(x, y) exists on the EC, the results of Equations 32 and 33 may be equal to the output point Q(x, y). Otherwise, the results of Equations 32 and 33 may be changed to non-predictable faulted values in operation S65.

After the computations of Equations 32 and 33, if necessary, the results may be converted to another point representation according to Equations 8 through 24 in operations S63 and S64.

The non-faulted encrypted output point Q=k·P′ may be output to a post-processor of an upper layer in operation S65.

As described above, a cryptographic method and apparatus thereof may be implemented in Weierstrass and Hessian forms according to example embodiments of the present invention, and may be an effective DFA counter-measurement based on different point representations in the ECC. For the point representations, Affine, Ordinary Projective, Jacobian Projective, and Lopez-Dahab Projective may be used.

As described above, a cryptographic method and apparatus thereof according to example embodiments of the present invention may prevent confidential information from being leaked by checking faults due to DFA attacks in a base point, faults in definition fields, and faults in EC parameters before outputting final cryptographic results. Accordingly, it may be advantageous for the cryptographic method and apparatus thereof to be applied to a crypto-system requiring DFA, SCA, Timing Analysis, Power Analysis, Electro-Magnetic Analysis attack-resistance and quick operational speed.

The example embodiments of the present invention may be written as a computer program and may be implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, DVDs, etc.), and storage media such as carrier waves (e.g., transmission through the internet). The computer-readable recording medium can also be distributed over network coupled computer systems so that the computer-readable code is stored and executed in a distributed fashion.

While the present invention has been particularly shown and described with reference to example embodiments thereof, it will be understood by those skilled in the art that various changes in form and details may be made therein without departing from the scope of the present invention. The above-described example embodiments should be considered in a descriptive sense only and are not for purposes of limitation.

What is claimed is:

1. A cryptographic method, comprising:
providing elliptic curve (EC) domain parameters, a binary check code (BCC), an input point, and a secret key;
determining whether a value calculated based on the EC domain parameters is equal to the BCC;
determining whether the input point exists on an elliptic curve (EC) defined by the EC domain parameters;
generating an encrypted output point by performing scalar multiplication on the input point and the secret key using the EC domain parameters;
determining whether the encrypted output point exists on the EC defined by the EC domain parameters; and
outputting the encrypted output point if the value calculated based on the EC domain parameters is equal to the BCC and if the input point and the encrypted output point exist on the EC, and not outputting the encrypted output point if the value calculated based on the EC domain parameters is not equal to the BCC or if the input point or the encrypted output point does not exist on the EC.

2. The method of claim 1, wherein determining whether the value calculated based on the EC domain parameters is equal to the BCC is performed after generating the encrypted output point.

3. The method of claim 2, wherein determining the value calculated based on the EC domain parameters is equal to the BCC is performed by an equation “a⊕b⊕p|n⊕BCC” using an XOR operation, and wherein a,b,p|n denotes the EC domain parameters, where a,b,p are applied to the case of a prime finite field [GF(p)] and a,b,n are applied to the case of a binary finite field [GF(2″)].

4. The method of claim 1, further including converting the input point to another point representation and generating the encrypted output point from the point-converted input point.

5. The method of claim 1, further including converting the encrypted output point to another point representation.

6. The method of claim 1, further including;
determining the existence of the input point on the EC by calculating “x³+ax+b” and “y²” to determine whether y²=x³+ax+b in Weierstrass Affine (WA) coordinates in a prime finite field [GF(p)] is satisfied; and
performing an XOR operation of the calculated values, where (x, y) is the input point, and a and b are the EC domain parameters.

7. The method of claim 1, further including:
determining the existence of the input point on the EC by calculating “X³+aXZ²+bZ³” and “Y²Z” to determine whether Y²Z=X³+aXZ²+bZ³ in Weierstrass Ordinary Projective (WP) coordinates in a prime finite field [GF(p)] is satisfied; and
performing an XOR operation of the calculated values, where (X, Y, Z) is the input point, and a and b are the EC domain parameters.

8. The method of claim 1, further including:
determining the existence of the input point on the EC by calculating “X³+aXZ⁴+bZ⁶” and “Y²” to determine whether Y²=X³+aXZ⁴+bZ⁶ in Weierstrass Jacobian Projective (WJ) coordinates in a prime finite field [GF(p)] is satisfied; and
performing an XOR operation of the calculated values, where (X, Y, Z) is the input point, and a and b are the EC domain parameters.

9. The method of claim 1, further including:
determining the existence of the input point on the EC by calculating “X³Z+aXZ³+bZ⁴” and “Y²” to determine whether Y²=X³Z+aXZ³+bZ⁴ in Weierstrass Lopez-Dahab Projective (WL) coordinates in a prime finite field [GF(p)] is satisfied; and
performing an XOR operation of the calculated values, where (X, Y, Z) is the input point, and a and b are the EC domain parameters.

10. The method of claim 1, further including:
determining the existence of the input point on the EC by calculating “x³+ax²+b” and “y²+xy” to determined whether y²+xy=x³+ax²+b in Weierstrass Affine (WA) coordinates in a binary finite field [GF(2″)] is satisfied; and
performing an XOR operation of the calculated values, where (x, y) is the input point, and a and b are the EC domain parameters.

11. The method of claim 1, further including:
determining the existence of the input point on the EC by calculating “X³Z+aX²Z+bZ³” and “Y²Z+XYZ” are calculated to check if Y²Z+XYZ=X³Z+aX²Z+bZ³ in Weierstrass Ordinary Projective (WP) coordinates in a binary finite field [GF(2″)] is satisfied; and
performing an XOR operation of the calculated values, where (X, Y, Z) is the input point, and a and b are the EC domain parameters.

12. The method of claim 1, further including:
determining the existence of the input point on the EC by calculating “X³+aX²Z²+bZ⁶” and “Y²+XYZ” are calculated to check if Y²+XYZ=X³+aX²Z²+bZ⁶ in Weierstrass Jacobian Projective (WJ) coordinates in a binary finite field [GF(2″)] is satisfied; and
performing an XOR operation of the calculated values, where (X, Y, Z) is the input point, and a and b are the EC domain parameters.

13. The method of claim 1, further including:
determining the existence of the input point on the EC by calculating “X³Z+aX²Z²+bZ⁴” and “Y²+XYZ” are calculated to check if Y²+XYZ=X³Z+aX²Z²+bZ⁴ in Weierstrass Lopez-Dahab Projective (WL) coordinates in a binary finite field [GF(2″)] is satisfied; and
performing an XOR operation of the calculated values, where (X, Y, Z) is the input point, and a and b are the EC domain parameters.

14. The method of claim 1, further including:
determining the existence of the input point on the EC by calculating “u³+v³+1” and “Duv” are calculated to check if u³+v³+1=Duv in Hessian Affine (HA) coordinates is satisfied; and
performing an XOR operation of the calculated values, where u and v are functions of the input point (x, y) and D, and D is the EC domain parameter.

15. The method of claim 1, further including:
determining the existence of the input point on the EC by calculating “U³+V³+W³” and “DUVW” are calculated to check if U³+V³+W³=DUVW in Hessian Ordinary Projective (HP) coordinates is satisfied; and
performing an XOR operation of the calculated values, where U, V and W are functions of the input point (x, y) and D, and D is the EC domain parameter.

16. A cryptographic method, comprising:
providing elliptic curve (EC) domain parameters, a binary check code (BCC), a first input point, and a secret key;
generating a second input point using the EC domain parameters and the BCC;
generating an encrypted output point by performing scalar multiplication on the second input point and the secret key using the EC domain parameters;
generating a first information signal indicating whether the first input point is equal to the second input point re-estimated from the EC domain parameters and the BCC;
generating a second information signal indicating whether the encrypted output point exists on an elliptic curve (EC) defined by the EC domain parameters; and
performing an XOR operation of the first information signal, the second information signal, and the encrypted output point.

17. The method of claim 16, wherein the BCC is defined by BCC=P⊕a⊕b⊕p|n, where P denotes the first input point, and a,b,p|n denotes the EC domain parameters where a,b,p is applied to the case of prime finite field [GF(p)] and a,b,n is applied to the case of a binary finite field [GF(2″)].

18. The method of claim 16, further including:
converting the second input point is converted to another point representation, and
generating the encrypted output point from a point-converted second input point.

19. The method of claim 16, wherein the first input point is converted to another point representation.

20. The method of claim 16, further including converting the XOR operation result to another point representation.

21. A cryptographic apparatus, comprising:
a scalar multiplication unit adapted to receive an input point and a secret key, and generate an encrypted output point by performing scalar multiplication using elliptic curve (EC) domain parameters;
a domain checker adapted to check whether a value calculated based on the EC domain parameters is equal to a binary check code (BCC); and
a point checker adapted to determine whether the input point and the encrypted output point exist on an elliptic curve (EC) defined by the EC domain parameters,
wherein, if the value calculated based on the EC domain parameters is equal to the BCC and if the input point and the encrypted output point exist on the EC, the encrypted output point is output, and if the value calculated based on the EC domain parameters is not equal to the BCC or if the input point or the encrypted output point does not exist on the EC, the encrypted output point is not output.

22. The apparatus of claim 21, wherein the domain checker is adapted to check if the value calculated based on the EC domain parameters is equal to the BCC at least one of before and after the generation of the encrypted output point.

23. The apparatus of claim 21, wherein the point checker includes:
a first point checker adapted to check the input point; and
a second point checker adapted to check the encrypted output point.

24. The apparatus of claim 21, further including:
a non-volatile memory adapted to store and provide the EC domain parameters, the BCC, and the secret key.

25. The apparatus of claim 21, further including:
a first point representation converter adapted to convert the input point to another point representation, wherein the scalar multiplication unit generates the encrypted output point from the point-converted input point.

26. The apparatus of claim 25, wherein the first point representation converter is adapted to convert the encrypted output point generated by the scalar multiplication unit to another point representation.

27. The apparatus of claim 25, further including:
a second point representation converter adapted to convert the encrypted output point generated by the scalar multiplication unit to another point representation.

28. The apparatus of claim 26, wherein the point checker includes:
a first point checker adapted to check the input point; and
a second point checker adapted to check the encrypted output point.

29. The apparatus of claim 28, wherein the first point representation converter is adapted to convert the encrypted output point to another point representation after the checking of the second point checker is performed.

30. The apparatus of claim 23, further including:
a third point representation converter adapted to convert the encrypted output point to another point representation after checking of the second checker is performed.

31. The apparatus of claim 21, wherein the domain checker checks a⊕b⊕p|n⊕BCC using an XOR operation, where a,b,p|n denotes the EC domain parameters where a,b,p is applied to the case of a prime finite field [GF(p)] and a,b,n is applied to the case of a binary finite field [GF(2″)].

32. The apparatus of claim 31, wherein the point checker comprises a plurality of unit point checking elements, and wherein a number of the plurality of unit point checking element is odd.

33. The apparatus of claim 32, further including:
a plurality of point representation converting elements corresponding to the number of unit point checking elements, and adapted to convert the input point to other point representations, and output the converted point representations to the plurality of unit point checking elements.

34. A cryptographic apparatus, comprising:
an input point computation circuit adapted to generate a second input point using elliptic curve (EC) domain parameters and a binary check code (BCC), which is a function of a first input point;
a scalar multiplication computation circuit adapted to receive the second input point and a secret key and generate an encrypted output point by performing scalar multiplication using the EC domain parameters;
a domain checking circuit adapted to generate a first information signal indicating whether the first input point is equal to the second input point estimated from the EC domain parameters and the BCC; and
an output circuit generating a second information signal indicating whether the encrypted output point exists on an elliptic curve defined by the EC domain parameters (EC) and performing an XOR operation of the first information signal, the second information signal, and the encrypted output point.

35. The apparatus of claim 34, wherein the BCC is defined by BCC=P⊕a⊕b⊕p|n,where P denotes the first input point, and a,b,p|n denotes the EC domain parameters where a,b,p is applied to the case of a prime finite field [GF(p)] and a,b,n is applied to the case of a binary finite field GF(2″).

36. The apparatus of claim 34, further including:
a non-volatile memory storing and providing the first input point, the EC domain parameters, the BCC, and the secret key.

37. The apparatus of claim 34, further including:
a point representation conversion circuit adapted to convert the second input point to another point representation, wherein the scalar multiplication computation circuit generates the encrypted output point from the point-converted second input point.

38. The apparatus of claim 37, wherein the point representation conversion circuit is adapted to convert the first input point to another point representation.

39. The apparatus of claim 37, wherein the point representation conversion circuit is adapted to convert the XOR computation result to another point representation.
